(19) United States
(12) Patent Application Publication
(10) Pub. No.: US 2025/0035808 A1
(43) Pub. Date: Jan. 30, 2025

(54) ELECTROMAGNETIC METAMATERIAL FOR BOREHOLE RADAR POWER EMISSION AMPLIFICATION

(71) Applicant: Saudi Arabian Oil Company, Dhahran (SA)

(72) Inventors: Dwight W. Swett, Cypress, TX (US); Robert W. Adams, Houston, TX (US)

(21) Appl. No.: 18/784,458

(22) Filed: Jul. 25, 2024

Related U.S. Application Data
(60) Provisional application No. 63/529,591, filed on Jul. 28, 2023.

(51) Int. Cl. G01V 3/30; G01S 13/02; G01S 13/88

(52) U.S. Cl. CPC G01V 3/30; G01S 13/0209; G01S 13/885

(57) ABSTRACT

Borehole radar systems send a radar pulse into the subterranean formation using a transmitter. The radar pulse is reflected back when it encounters a formation feature that has a different electromagnetic property. The receiver receives the reflected energy back. However, in a highly conductive rock or in the presence of highly conductive fluids in the borehole region, the radar pulse is not transmitted far enough with sufficient intensity to be detected by the receivers. This technology provides a design for a device which amplifies the radar transmitted power, using a metamaterial. The metamaterial enhanced device is designed for an electric source frequency ranging between 1-5 GHz. Further, a metamaterial based antenna design achieves a directivity over D=20. This provides high intensity far field radiation into the subterranean formation which can be detected by the receivers with high signal to noise ratio (SNR).

### BACKGROUND

Assuring the long-term, safe underground storage of gases such as CO₂ and H₂ requires the development of effective monitoring strategies. As part of the geophysical monitoring effort, deployment of borehole electromagnetic measurements is an important method to monitor the gas movement within the reservoir as well as any changes to the geology associated with fractures and lithology. Borehole-radar reflection is an effective method which can provide the necessary information to characterize the location, orientation, and lateral extent of fracture zones surrounding the borehole, as well as lithologic changes, occurring within the formation of underground gas storage programs. Any leakage pathways for gas will displace saline brine in the reservoir, and because the gases have a high resistivity compared to brine, any local resistivity increases in the formation can be monitored and mapped in 3D by measuring electric or magnetic fields using the borehole radar system.

### SUMMARY

This technology relates to the design and use of a metamaterial to amplify the electromagnetic power emission in a borehole radar system.

### BRIEF DESCRIPTION OF DRAWINGS

FIGS. 1A and 1B are each a drawing of a borehole radar system and its resultant radar measurement.

FIG. 2 are modelled plots of three-point reflectors at variable spacing.

FIGS. 3A and 3B are plots of detection resolution.

FIG. 4 is a schematic of various performance improvements achieved in antennas using metamaterials.

FIG. 5 is a schematic drawing of a borehole radar source amplification module using metamaterials.

FIG. 6 is a drawing of an implementation of a metamaterial radar amplifier in a borehole.

FIGS. 7A, 7B, and 7C are drawings of a geometrical inversion for a metamaterial radiation amplification cell.

FIGS. 8A, 8B, and 8C are drawings of a geometrical conversion for signal-to-noise ratio (SNR) enhancement through suppression of direct longitudinal electric fields.

FIGS. 9A and 9B are plots of 3D far-field electrical radiation patterns for a metamaterial cell geometry.

FIGS. 10A and 10B are plots of a simulation for far-field electrical radiation patterns using metamaterial lens for dipole modes with frequencies below 2 GHz and above 2 GHz, respectively.

FIGS. 11A and 11B are far-field electrical radiation patterns for a reference dipole source without the metamaterial lens.

FIGS. 12A and 12B are far-field amplification of dipole electrical emission using electromagnetic metamaterials lens.

FIG. 13 is a plot of a combined far-field power amplification and longitudinal suppression of electric field for SNR enhancement.

FIG. 14 is a schematic drawing of the use of metamaterials as isolators between electromagnetic (EM) receivers and EM transmitters.

FIG. 15 is a schematic drawing of the use of metamaterials as EM receivers and EM transmitters.

FIG. 16 is a schematic drawing of the use of metamaterials as both isolators and in the EM receivers and EM transmitters.

FIGS. 17A, 17B, and 17C are additional implementations of metamaterial cellular geometries.

FIG. 18 is a schematic drawing of the horizontal polarization plane for a directional borehole radar application.

FIGS. 19A and 19B are the normalized electric field radiation patterns at 4.1 GHz for a metamaterial cell using the cell geometry of FIGS. 17A-C.

FIGS. 20A and 20B show the normalized electric field radiation patterns for the XZ horizontal plane and YZ transverse plane, respectively, at frequencies ranging between 4-4.4 GHz.

FIGS. 21A and 21B show the normalized electric field radiation patterns for a dipole at 3.9 GHz without a metamaterial.

FIG. 22 is a comparison of the radiation pattern directivities obtained for a dipole with and without a metamaterial.

FIG. 23 shows the metamaterial antenna implementation in a dipole source module.

### DETAILED DESCRIPTION

Borehole radar (BHR) is one of the most important types of ground-penetrating radar (GPR). It has been widely applied in geological survey, geophysical exploitation, civil engineering, and mineral resources exploitation, including subsurface fracture detection, soil water content measurement, tunnel detection, and oil well perforation monitoring. The principles of borehole radar reflection logging involve an electromagnetic arrangement of transmitter(s) and receiver(s). In the BHR system a radar pulse is transmitted into the bedrock surrounding the borehole. The transmitted pulse moves away from the borehole until it encounters material with different electromagnetic properties, such as a fracture zone, change in rock type, void, as well as gas leakage in pathways.

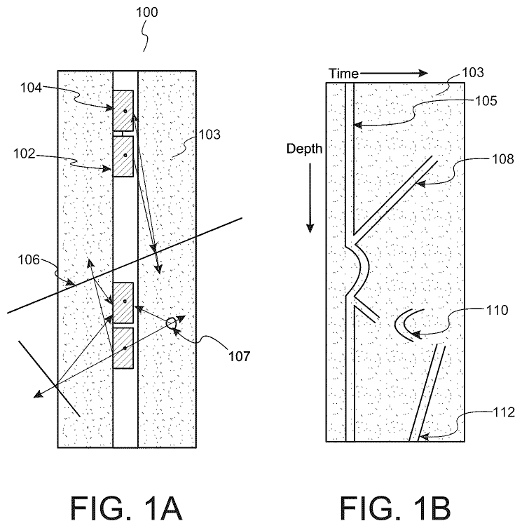

FIGS. 1A and 1B are each a drawing of a borehole radar system and its resultant radar measurement. A borehole radar system 100 is installed in a borehole which is drilled in a subterranean formation 103. The figure shows the orientation of a transmitter and receiver in a single borehole. A transmitter 102 sends a radar pulse into the subterranean formation 103 surrounding the borehole. A radar pulse is generated from an electric dipole source placed in the transmitter 102. The transmitted radar pulse encounters a material with a different electromagnetic property compared to the subterranean formation 103. For example, the material can include a fracture 106 or a void as a point source 107 in the subterranean formation. The reflected pulse energy from the fracture 106 or the point source 107 is redirected to the receiver 104. The reflected pulse energy depends on the conductivity of the formation, permittivity, magnetic permittivity, and the radar pulse wave impedance. In some implementations, the borehole radar system includes several transmitters and receivers arranged adjacent to each other.

A resultant radar measurement of a fracture and a point reflector is shown in FIG. 1B. The reflected radar measurement is received by the receiver 104 in response to the transmitted radar pulse 105. In FIG. 1B, the examples include a reflected energy from a planar feature 108, reflected energy from a point object such as a void 110, and a reflected energy from a planar fracture not intercepting the borehole 112.

The use of borehole radar methods is limited by subsurface conditions and available equipment. The radial distances that can be penetrated and the scale of structures that can be resolved depend on several factors: the electromagnetic properties of the rock and ground water, the frequency range of interrogation, the output power of the transmitter, and the sensitivity of the receiver system antennas. EM radar-wave penetration distances are primarily controlled by the electrical conductivity of the medium through which the radar waves propagate. In electrically conductive rocks, such as shale, mudstone, or in geologic materials that contain saline water or mineralogic clay, EM waves may penetrate less than a meter. In more electrically resistive rocks, such as granite or gneiss, EM waves may penetrate tens of meters. A fundamental constraint of borehole radar is that the higher frequency antennas provide a more detailed image than the lower frequency antennas; however, the lower frequency antennas provide greater penetration. This phenomenon is described by the relation:

$$Δ L = \sqrt{\frac{R {λ}_{c}}{2}} \qquad eq . ( l )$$

where ΔL is the minimum required separation distance for objects to be resolved as distinct, R is the radial distance from the borehole radar, and λ_{c} is the EM wavelength in the rock.

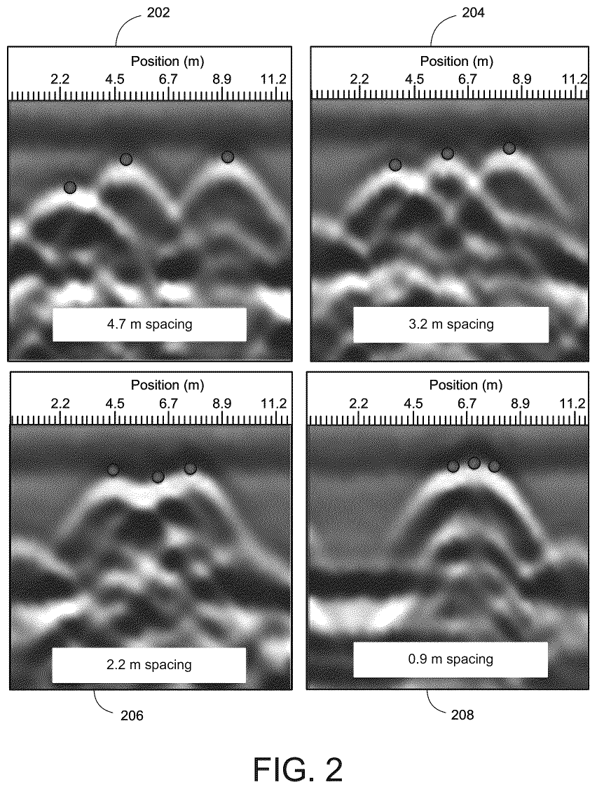

FIG. 2 are modelled plots of three-point reflectors at variable spacing. It is an illustrative example with three point-reflectors, which are modeled at variable reflector spacings. Plot 202 shows a spacing of 4.7 m. Plot 204 shows a spacing of 3.2 m. Plot 206 shows a spacing of 2.2 m, and plot 208 shows a spacing of 0.9 m. The radial distance in this example is 100 m from the borehole radar, at a borehole radar frequency of 1 GHz. The EM velocity in the rock used in the model is 0.1 m/ns.

For monitoring of underground gas storage, investigation distances R>50 m from the wellbore will be required due to the large standoffs necessary to avoid introduction of hydrogen leakage pathways caused by the monitoring wells. Compounding the challenge, it is often necessary to image features separated less than ΔL=1 m. As an example of the resolution challenge at these distances of investigation, the plots in FIG. 2 correspond to analyses of borehole radar operating at 1 GHz in a rock formation having EM velocity of 0.1 m/ns (λ_{c}=0.1 m) at a distance of 100 m from the borehole. The plots show the discernibility of three point-reflectors spaced at different dimensions. It is apparent that the three point-reflectors are not distinguishable at a spacing of 0.9 m (208) but can still be barely distinguished at 2.2 m spacing (206). This illustrates that a 1 m resolution in this type of rock media will require a borehole radar transmitter operating well above 1 GHz frequency.

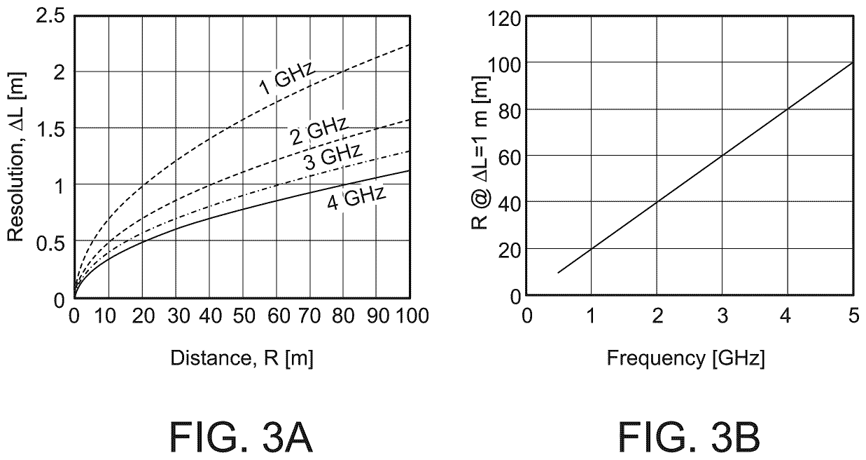

FIGS. 3A and 3B are plots of detection resolution. FIG. 3A shows the resolution, ΔL versus radial distance R, for different source frequencies. FIG. 3B shows the maximum detection distance within a resolution of ΔL=1 m for a range of source frequencies. The EM velocity in the rock is modeled as 0.1 m/ns.

In the far field the electric intensity (W/m²) diminishes as 1/R² away from a (low frequency) dipole source. Anomalous fields due to localized targets fall off similarly, making imaging of localized zones at distances over 10 m extremely difficult. For this example set of rock properties, the calculations indicate a borehole radar source operating at 2.5 GHz frequency with an output power in excess of 25 times than that found in state-of-the-art technologies would be required for sub-meter resolution at R=50 m investigation distances. Such a technology is not currently available in the state-of-the-art.

The antenna is an important component of BHR as it significantly affects the radar performance, and considerable research has been devoted to advancement of antenna designs for BHR. In recent studies, transverse electromagnetic horn antenna, thick dipole, and Vivaldi antenna, have been used in the design of BHR systems due to their wide bandwidth and low dispersion. However, these antennas generally work only at low frequencies (˜450 MHZ) and suffer from poor detection distance due to limited radiated power capability. In other studies, resistive loading traveling-wave dipole antennas have been used for BHR due to good pulse radiation behavior and comparably compact size. However, these antenna designs suffer from poor radiation efficiency since a significant portion of the electromagnetic energy is dissipated by the loaded resistors, which results in poor overall performance of the BHR system.

Wideband dipoles, such as biconical, diamond, ellipse, and triangular shape, as well as micro-strip dipole antenna, can provide better efficiency, but the antenna size in these designs generally exceeds the volumetric limitations of BHR. Recently, step-shaped feed gap, small metal strips (wings), folded structure, U-shaped patch, parasitic patch, and slender stub structure were applied to broaden the working bandwidth and improve the compactness in size of a dipole antenna, but these all remain insufficient to meet the demanding size constraints for an oilfield BHR requirement.

To achieve a long penetration distance from the borehole, most borehole radar systems are operated at frequencies between 10 MHz to 100 MHz. This has resulted in relatively poor resolution at investigation distances exceeding about 10 m and is a major limitation of the existing BHR technologies. In many geological imaging applications, the characterization of subsurface fractures at large penetration distances would be very important information in designing reservoir production programs. However, such an analysis is extremely difficult with conventional borehole radar as these technologies can only estimate the location and orientation of fractures at large penetration distances with little detailed information on the physical properties. To address this limitation in the conventional technology, much higher power outputs at frequencies f_{c}>2 GHz are needed with minimal degradation in signal-to-noise-ratio (SNR) compared to existing technologies. For this, an antenna design is important for borehole radar systems.

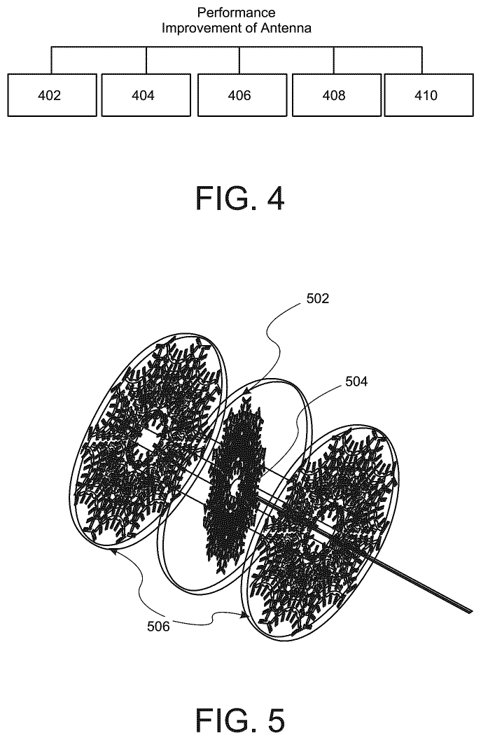

FIG. 4 is a schematic of various performance improvements achieved in antennas using metamaterials. The performance of antennas and antenna systems can be enhanced with the aid of metamaterial-based structures. Some of the characteristics that can be improved are bandwidth enhancement 402, gain improvement 404, efficiency improvement 406, size reduction 408, and isolation improvement 410. Some metamaterial structures are on the same plane as that of the antenna, etched directly on the same substrate as that of the radiating element in an effort to improve the compactness in size of the antenna design. In this design methodology, the backscattering of the propagation element is minimized and a relatively directional radiation pattern is observed. In some implementations, the current distribution is varied using two geometrically different metamaterials and two metamaterials with the same geometry but different orientations. This creates a more directional radiation pattern, resulting in a higher gain on the output electric field.

However, none of these developments provide the radiation amplification needed to achieve sub-meter imaging resolutions at distances R>10 m in highly conductive rock formations. The description below provides details of a device which amplifies dipole borehole radar emission within the mechanical and electrical constraints of a borehole environment.

FIG. 5 is a schematic drawing of a borehole radar source amplification module using metamaterials. The disclosed device includes an electromagnetic metamaterial lens 502 that encloses an electric dipole source 504. The metamaterial lens 502 amplifies power in the radar frequency range from the electric dipole source 504. The metamaterial lens 502 enhances the radiated EM power by more than 100× over certain frequency bandwidths, when operated in an electrically conductive reservoir rock formation, including types with high electrical conductivity (i.e., s>0.1 S/m). Additionally, an array of metamaterial cells 506 are placed axially on either side of the electric dipole source 504. The metamaterial cells 506 absorb the direct longitudinal electromagnetic energy from the electric dipole source 504 to isolate the receiver arrays (not shown) and enhance SNR.

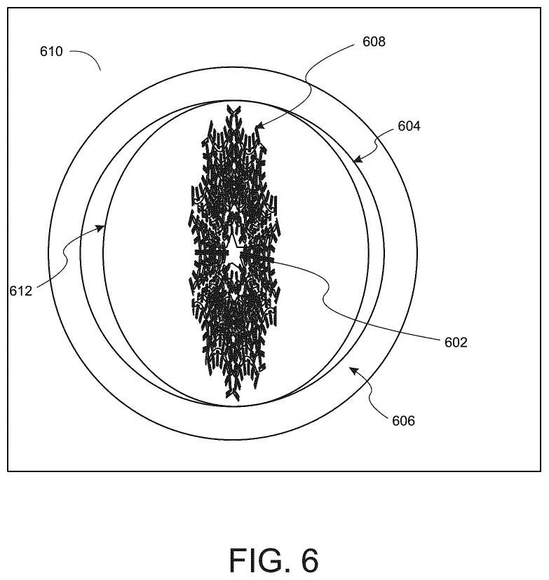

FIG. 6 is a drawing of an implementation of a metamaterial radar amplifier in borehole. An electric dipole source 602 is embedded within the interior of logging tool 604. The logging tool is non-conductive and it is immersed in a wellbore fluid 606. An EM metamaterial lens 608 is disposed around the electric dipole source 602. The logging tool along with the wellbore fluid is placed in a subterranean formation 610.

The electromagnetic radar amplification metamaterial design described in FIG. 6 can be integrated as an electrically conductive material. This includes materials such as copper mesh printed on a substrate and surrounding the electrical dipole source 602 within a downhole logging tool 604. The logging tool 604 is electrically isolated from the conductive wellbore fluid 606 using methods such as a fiberglass structural tool housing 612. The intended implementation addresses one of the most challenging radar applications downhole, that involves imaging within a highly conductive wellbore fluid media, as well as highly conductive rock formations.

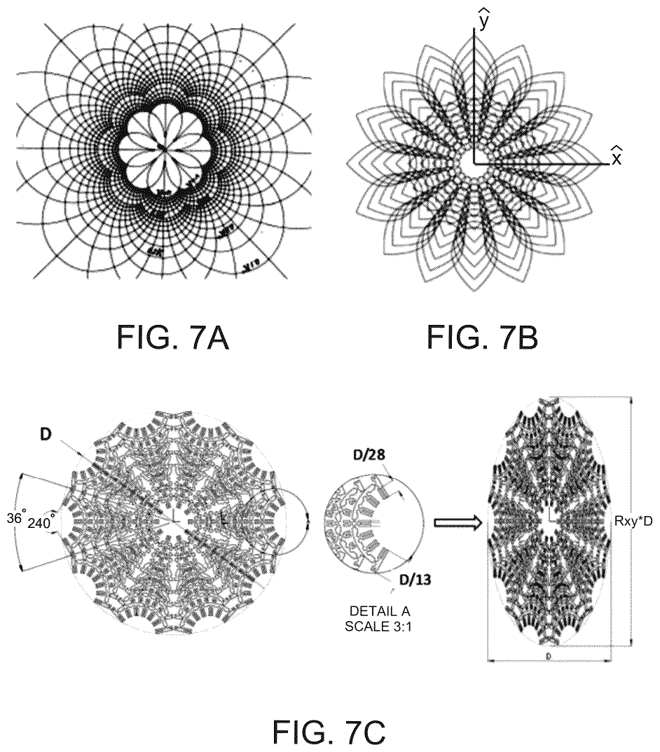

FIGS. 7A, 7B, and 7C are drawings of a geometrical inversion for a metamaterial radiation amplification cell. FIG. 7A is a reference of a conformal mapping contour. FIG. 7B is a geometric inversion of the reference conformal contours. FIG. 7C is a geometry of a metamaterial cell formed along the inverted conformal contours, highlighting an anisotropy factor Rxy.

A first geometry, based upon the transformation of a set of canonical Rhodonea conformal mapping contours (has a similarity with plant foliage) was developed, that was found to lead to a perfect absorption of vibrational energy in solid materials. Further, a second geometric inversion based on a different conformal mapping was developed for an acoustic media. It was determined that the second geometric inversion for the acoustic media led to an order of magnitude amplification of acoustic radiation in downhole fluids, over multiple broad bandwidths from 1-3 kHz. In implementations here, the inversion of the first geometry was found to develop extreme amplification of electromagnetic emission in the radar frequency range, which is important for downhole borehole radar reflection imaging applications.

The conversion to electromagnetic wave amplification is accomplished by inverting the solid/void configuration that was used in the elastic wave design, to an EM cell design that consists of an electrically conductive solid material in a pure vacuum background (or insulative material), as opposed to the elastic wave cellular design that was comprised of voids (vacuum or air) in a background solid metal.

The geometry derivation considers the conformal mapping from Cartesian coordinate space to a new virtual domain described by the relations:

$$x = \frac{1}{ρ} \sqrt{ρ + u} \qquad eq . ( 2 )$$

$$y = \frac{1}{ρ} \sqrt{ρ - u} \qquad eq . ( 3 )$$

$$ρ = \sqrt{{u}^{2} + {v}^{2}} \qquad eq . ( 4 )$$

which is illustrated graphically in FIG. 7A. A geometric inversion of the conformal contours can be accomplished using the relations:

$$\hat{x} = \frac{1}{ρ} \sqrt{ρ + u} - \sqrt{\frac{8}{u}} \qquad eq . ( 5 )$$

$$\hat{y} = \frac{1}{ρ} \sqrt{ρ - u} \qquad eq . ( 6 )$$

The geometry transformation using Eq. 5-6 gives a new set of non-conformal contours that in effect ‘invert’ the original conformal mapping geometry from inside-out as illustrated in FIG. 7B. This results in a leaf-pattern set of truncated contours. A graphical illustration of the resulting metamaterial cell geometry is shown in the lower left of FIG. 7C with a detail of an anisotropic scaling depicted in the lower right.

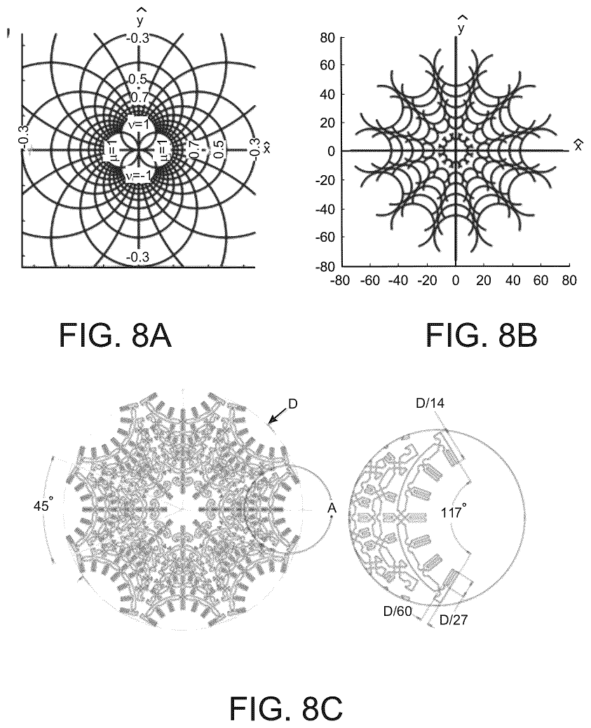

FIGS. 8A, 8B, and 8C are drawings of a geometrical conversion for signal-to-noise ratio (SNR) enhancement through suppression of direct longitudinal electric fields.

The metamaterial cell array for suppression of the direct axial electric field noise is based on an isotropic shape factor in the elastic metamaterial cell design. In FIGS. 7A-C, the anisotropic cellular geometry promotes suppression of the direct axial electric field noise. The geometry derivation considers the conformal mapping from Cartesian coordinate space to a new virtual domain described by the relations:

$$x = \frac{u}{{u}^{2} + {v}^{2}} \qquad eq . ( 7 )$$

$$y = \frac{v}{{u}^{2} + {v}^{2}} \qquad eq . ( 8 )$$

which is illustrated graphically in FIG. 8A.

FIG. 8A is a geometric reference for conformal mapping contours. FIG. 8B is a geometric inversion of the reference conformal mapping contours. FIG. 8C is an isotropic geometry of a metamaterial cell.

A geometric inversion of the conformal contours can be accomplished using the relations:

$$\hat{x} = \frac{- [ {u}^{2} + 2 {v}^{2} ]}{{u}^{3} + u {v}^{2}} \qquad eq . ( 9 )$$

$$\hat{y} = \frac{v}{{u}^{2} + {v}^{2}} \qquad eq . ( 10 )$$

This geometry transformation gives a new set of non-conformal contours that in effect ‘invert’ the original conformal mapping geometry from inside-out as illustrated in FIG. 8B. This results in a tentacle-type set of truncated contours. A graphical illustration of the resulting isotropic metamaterial cell geometry is shown in FIG. 8C.

### Analysis Results

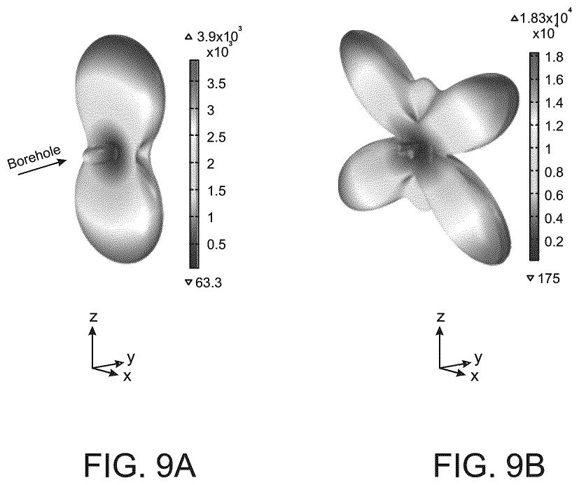

FIGS. 9A and 9B are plots of 3D far-field electrical radiation patterns for a metamaterial cell geometry. The metamaterial cell geometry has the following parameters: D=40 mm, Rxy=3.4. FIG. 9A has a 1.7 GHz dipole frequency emission. FIG. 9B has a 2.75 GHz dipole frequency emission. At the lower frequency emissions (<2 GHz, FIG. 9A) the radiation patterns are found consistently similar to the two-lobe dipole field, while at higher frequency emissions (>2 GHz, FIG. 9B) the radiation patterns are similar to a quadrupole distribution, for a range of cell geometries analyzed. The direct electric field along the borehole axis into the receiver array is minimal compared to the emission into the formation, promoting a very high SNR.

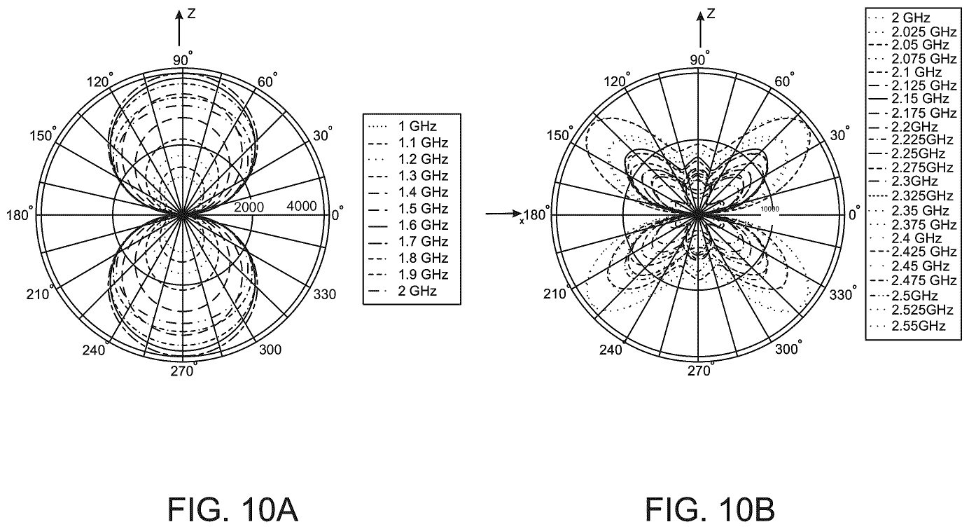

FIGS. 10A and 10B are plots of a simulation for far-field electrical radiation patterns using metamaterial lens for dipole modes with frequencies below 2 GHz and above 2 GHz, respectively. The metamaterial cell geometry has the following parameters: D=40 mm, Rxy=3.4. The figures show the simulation plots of the far-field electrical radiation pattern in the plane (X-Z) perpendicular to the borehole axis. At the lower frequency emissions (<2 GHz) the radiation patterns were found consistently similar to the two-lobe dipole field, while at higher frequency emissions (>2 GHz) the radiation patterns were similar to a quadrupole distribution, for the range of cell geometries analyzed. At higher frequencies, the quadrupole radiation patterns provide the means for finer resolution directionality detection. The far-field energy is concentrated at the orientations of ±36° and ±144°.

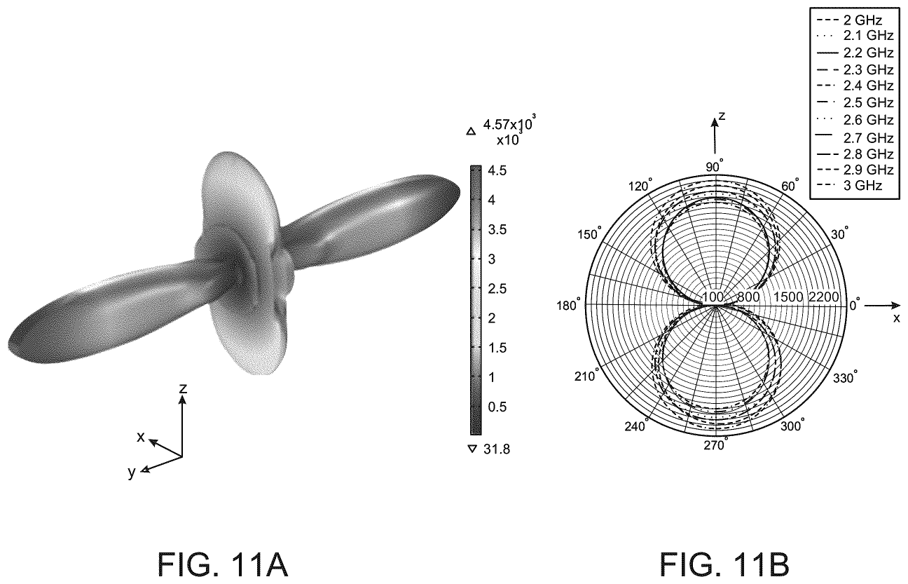

FIGS. 11A and 11B are far-field electrical radiation patterns for a reference dipole source without the metamaterial lens. A simulation plot of the 3D radiation pattern at 2.7 GHz is shown in FIG. 11A. A simulation plot of the 3D radiation pattern in the X-Z plane is shown in FIG. 11B. The baseline reference radiation pattern has a direct axial electric field which is significantly larger in magnitude than the actual far field emission into the rock formation. In contrast, the radiation pattern exhibited by the metamaterial source module (FIG. 9A-B, FIG. 10A-B) has a relatively negligible direct axial electric field component in proportion to the far field emission into the rock formation. The direct electric field along the borehole axis into the receiver array is much larger compared to the emission into the formation, leading to very poor SNR. Comparison of FIGS. 9A-B and FIGS. 11A-B shows the combined effects of the amplification lens and the SNR enhancement array when a metamaterial is used.

The baseline reference radiation pattern with no metamaterial exhibits a direct axial field amplitude ratio of about 2.3× relative to the far field emission. The metamaterial source module radiation pattern exhibits a direct axial field amplitude ratio of only about 0.25× relative to the far field emission, suggesting an almost 10× improvement in net SNR, in addition to the far field emission amplification.

### 2D Parametric Analyses

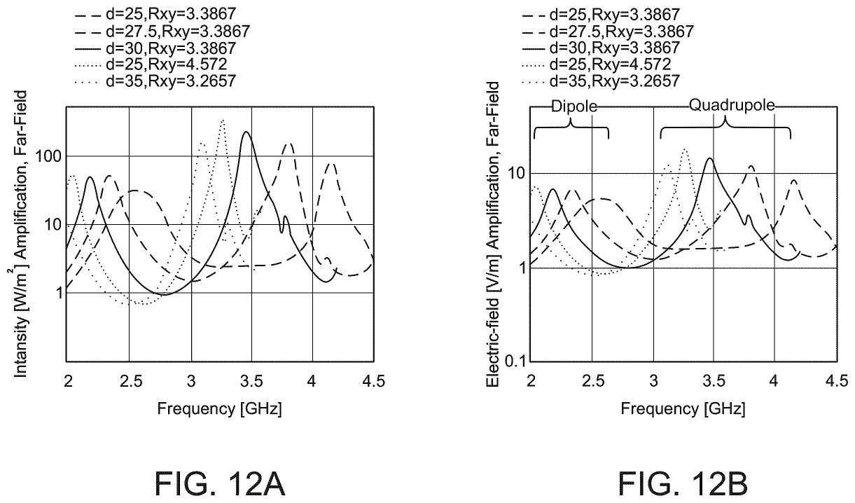

FIGS. 12A and 12B are far-field amplification of dipole electrical emission using electromagnetic metamaterials lens. FIG. 12A is a far-field power amplification of dipole electrical emission using electromagnetic metamaterial lens. FIG. 12B is a far-field electric field amplification of dipole electrical emission using EM metamaterial lens. The use of the EM metamaterial lens was investigated parametrically through finite element analysis (FEA). The parametric analyses were used to characterize the electrical dipole radiation amplification properties for various cell sizes and geometric anisotropy factors Rxy. The parametric electromagnetic spectra were calculated from 2D RF simulations using the commercially available Comsol® MultiPhysics 6.1 FEA software package.

The electrical dipole source amplification properties of the EM metamaterial lens are illustrated for different metamaterial cell sizes and anisotropic scaling factors Rxy. The module is adaptable for specific ranges of borehole radar logging frequency with change in cell size ‘D’ and/or anisotropy scaling factor ‘Rxy.’ Maximum far-field power amplification is 220× at 3.4 GHz, for a cell geometry of D=30 mm, Rxy=4.5. Maximum far-field electric field amplification is 14.6× corresponding to the same cell geometry and frequency.

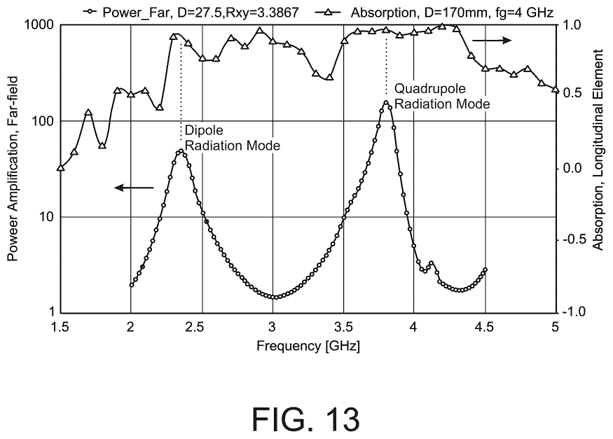

FIG. 13 is a plot of combined far-field power amplification and longitudinal suppression of electric field for SNR enhancement. The metamaterial design for longitudinal electric field absorption (top curve) can be tuned to match both the lower frequency dipole and higher frequency quadrupole radiation amplification modes (bottom curve) of the transmitter metamaterial element. The vertical axes are shifted for clarity.

The tunability of the longitudinal absorption metamaterial design to match both the low frequency dipole and higher frequency quadrupole radiation modes of a specific metamaterial transmitter element is illustrated in the example shown in the FIG. 13. In the example, the longitudinal absorption metamaterial element design is tuned to develop near perfect energy absorption at both the 2.4 GHz (dipole radiation mode) and 3.8 GHz (quadrupole radiation mode) frequencies of the transmitter metamaterial element. Thus, the conventional longitudinal electric field contaminating the longitudinally spaced receiver array signal is almost entirely eliminated resulting in enhanced SNR in both low frequency (dipole) and higher frequency (quadrupole) radiation modes of the transmitter metamaterial element.

The metamaterial structure can be implemented on a borehole electromagnetic imaging system to increase the SNR at higher frequencies. Implementations are detailed below.

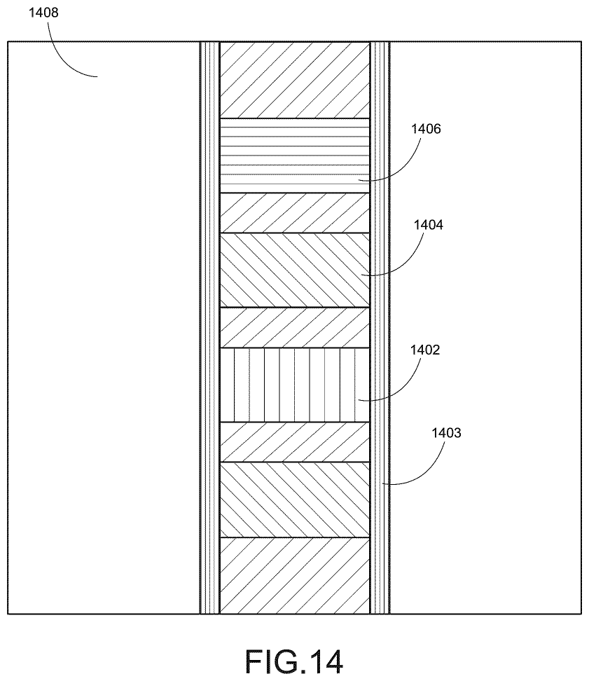

FIG. 14 is a schematic drawing of the use of metamaterials as isolators between electromagnetic (EM) receivers and EM transmitters. The EM transmitter 1402 is installed in a well logging tool. The well logging tool is immersed in a wellbore fluid 1403. The EM receiver 1406 is offset axially from the EM transmitter 1402. The EM transmitter 1402 and EM receiver 1406 are isolated from each other by an EM metamaterial isolator 1404 (also known as metamaterial absorbers). In some implementations, the system contains only metamaterial isolators to isolate conventional EM antenna transmitter and receivers from electromagnetic waves traveling axially through the borehole. This isolation reduces the effect of antenna crosstalk, ensuring EM waves traveling from one (or more) transmitters to one (or more) receivers is dominated by paths through the formation rather than through the borehole. The well logging tool is installed in a borehole formed in a subterranean formation 1408.

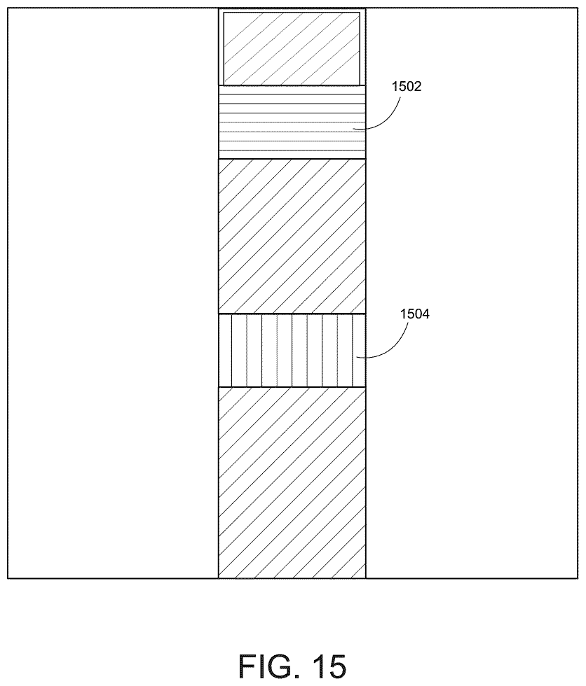

FIG. 15 is a schematic drawing of the use of metamaterials as EM receivers and EM transmitters. The system uses metamaterials as EM receivers 1502 and EM transmitters 1504. In some implementations, the system does not contain metamaterial absorbers but contains metamaterial amplifiers coupled to transmitting and/or receiving antennas. In this configuration without EM metamaterial isolators, an increase in SNR of EM waves traveling from one (or more) transmitters to one (or more) receivers is still achieved.

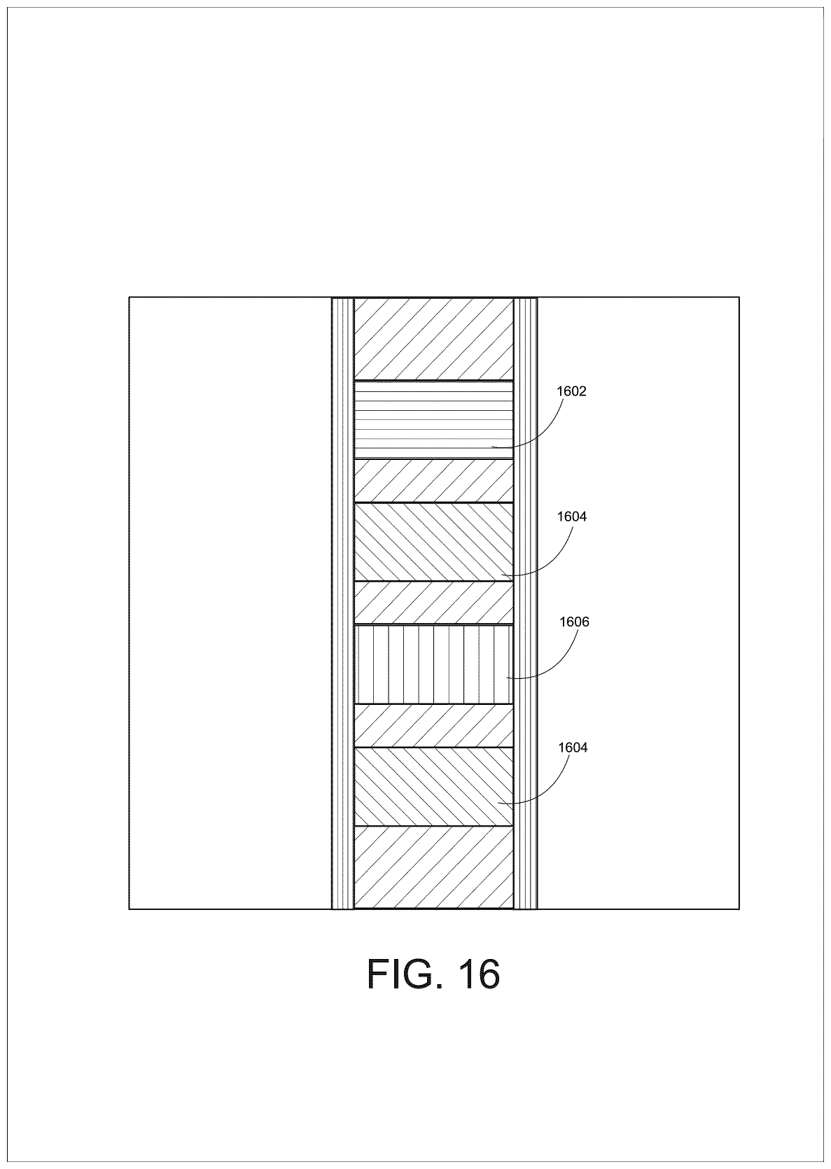

FIG. 16 is a schematic drawing of the use of metamaterials as both isolators and in the EM receivers and EM transmitters. The system uses metamaterials as isolators 1604 and in the EM receivers 1602 and EM transmitters 1606.

In some implementations, the system contains both metamaterial isolators 1604 to isolate axial transmission paths and metamaterial amplifiers coupled to transmitting and/or receiving antennas. This increases the SNR of the EM waves traveling from one (or more) transmitters to one (or more receivers) as well as ensuring the dominant path of the EM wave is through the formation rather than through the borehole.

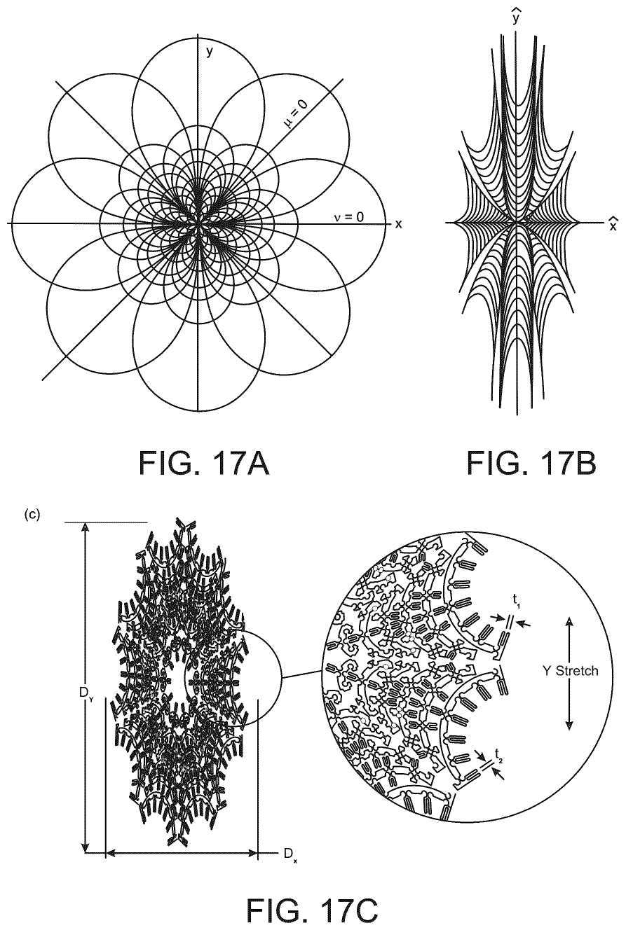

FIGS. 17A, 17B, and 17C are additional implementations of metamaterial cellular geometries. An alternative metamaterial cellular geometry with an improvement in the enhanced radiation amplification properties is implemented here. A reference conformal mapping contour of the metamaterial cellular geometry is shown in FIG. 17A. The geometric inversion of the reference conformal contours is illustrated in FIG. 17B. The metamaterial cell design formed along the inverted contours, which indicate nonlinear anisotropy is illustrated in FIG. 17C. The cellular geometry is derived from a mathematical perspective to exaggerate the interaction of sub-cell features with propagating EM waves. The resulting geometric patterns bear additional stretching transformations to mimic spider web geometries found in nature.

The geometry derivation for the improved cellular geometry considers the conformal contours mapping from Cartesian coordinate space to a new virtual domain as described by Eq. 2-4. A geometric inversion of the conformal contours can be accomplished using the relations:

$$\hat{x} = R cos ( ϕ ) \qquad eq . ( 11 )$$

$$\hat{y} = \pm G {\vert R sin ( ϕ ) \vert}^{γ} \qquad eq . ( 12 )$$

where γ is the stretching coefficient (real scalar), G is a cell size coefficient, and the geometric variables R and ϕ are given by:

$${R}^{2} = \frac{2}{ρ} [ 1 - \sqrt{\frac{2 ( ρ + u )}{u}} ] + \frac{8}{u} \qquad eq . ( 13 )$$

$$ϕ = {tan}^{- 1} [ \frac{\sqrt{ρ - u}}{\sqrt{ρ + u} - \sqrt{8 {ρ}^{2} {/}_{u}}} ] + \frac{π}{K} [ 2 k - 1 ] \qquad eq . ( 14 )$$

The symmetry fold coefficient (even integer) is represented by k which is also the cell geometry branch number. For the geometry example illustrated in FIG. 17A, the symmetry fold coefficient is k=10, and the stretching exponent is γ=1.7. The resulting metamaterial cellular geometry which incorporates the subwavelength resonance fork elements is illustrated in FIG. 17C. FIG. 17C includes a detail of the nonlinear anisotropy in the resonator's geometry due to the stretching inversion. The geometry transformation applies a nonlinear warp of the original geometric transformation previously described in FIGS. 7A-C, in a quasi-radial fashion, and superimposes a stretch along one axis of symmetry. The original geometric inversion described in FIGS. 7A-C is a single case having a stretch exponent γ=1.0. The stretching exponent in the inversion acts on a pointwise continuous fashion such that, the sub-cell resonator branches and stem forks are nonlinearly deformed to result in different lengths and widths between components within the cell. This stretch effect is illustrated in FIG. 17C. The comparison of stem fork widths t₁, t₂ at two different distances from the cell center in the stretch axis (ŷ) is shown as well.

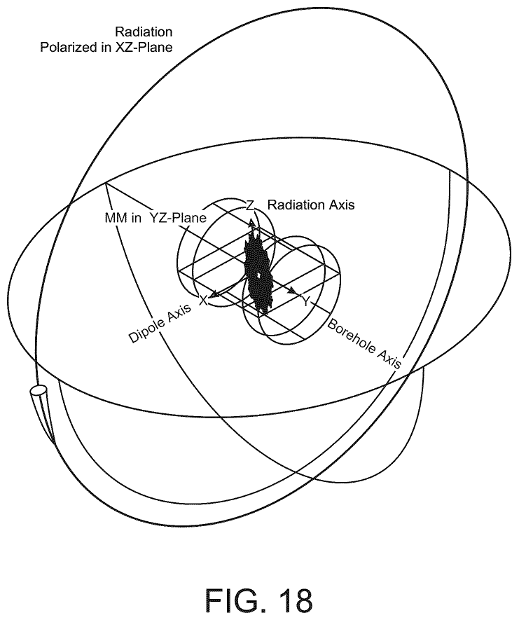

FIG. 18 is a schematic drawing of a horizontal polarization plane for directional borehole radar application. For 3-D measurements with a borehole radar, a directional antenna is used. In addition, it is preferred that the radiation is polarized in the horizontal plane relative to the borehole as illustrated in the FIG. 18. In the figure, the required horizontal polarization plane is the XZ-plane, with the direction of radiation in the Z-axis.

In the previous metamaterial design (FIG. 7A-C), horizontal polarization was achieved. However, the radiation pattern was not directional and exhibited a moderate improvement in directivity compared to conventional antenna designs. In the new metamaterial design (FIGS. 17A-C), the metamaterial uses an electric dipole and is combined with a semi-cylindrical perfectly conducting reflector in one direction, to produce radiation in the direction opposite to the semi-cylinder. The resulting radiation is directional and exhibits enhanced directivity relative to the state of the art.

A parameter of principal importance for the borehole radar application is directivity of the radiation pattern. Directivity is a measure of the concentration of an antennas's radiation pattern in a particular direction, such that a higher directivity also means that the beam will travel further. The directivity of an antenna is defined mathematically as the ratio of the maximum radiation intensity that an antenna creates in a particular direction divided by the average radiation intensity as if the radiation were theoretically distributed uniformly over a sphere. In effect, the directivity parameter can be used as a measure of relative radiation performance of different antenna designs. The most common (half-wave length) dipole antenna theoretically exhibits radiation in a vacuum with directivity of D=2.15, while 5/4-wave length dipole antenna has directivity of D=5.2, the highest of dipoles with similar length.

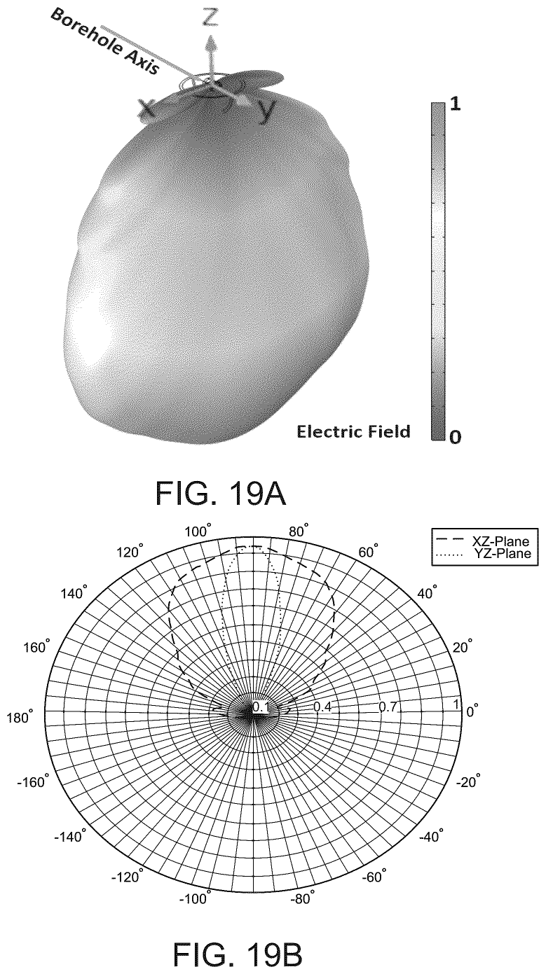

FIGS. 19A and 19B are the normalized electric field radiation patterns at 4.1 GHz for a metamaterial cell using the cell geometry of FIG. 17A-C. The metamaterial design is considered for a downhole design within a borehole filled with conductive fluid and surrounded by an electrically conductive rock formation. The borehole diameter is 7 inch with a conductivity of σ=0.001 S/m and relative permittivity of ε=5. The rock formation has a conductivity of σ=0.1 S/m and relative permittivity of ε=4.

The simulation of the far-field radiation pattern for a metamaterial cell geometry having G=0.05, [symbol] =1.7 is given in FIG. 19. A corresponding directivity of D=22.7 relative to the Z-axis direction in the horizontal plane of polarization is obtained. The borehole axis is along the Y direction. A 3D simulation of the far-field radiation pattern is shown in FIG. 19A. The 2D simulation of the far-field radiation patterns in the horizontal XZ plane (azimuth) and the transverse YZ plane (elevation) is shown in FIG. 19B. The radiation patterns show negligible side lobe development in either plane. It can be noted that there is effectively negligible radiation leakage down the borehole (Y-axis direction), that could potentially contaminate the receiver array signals

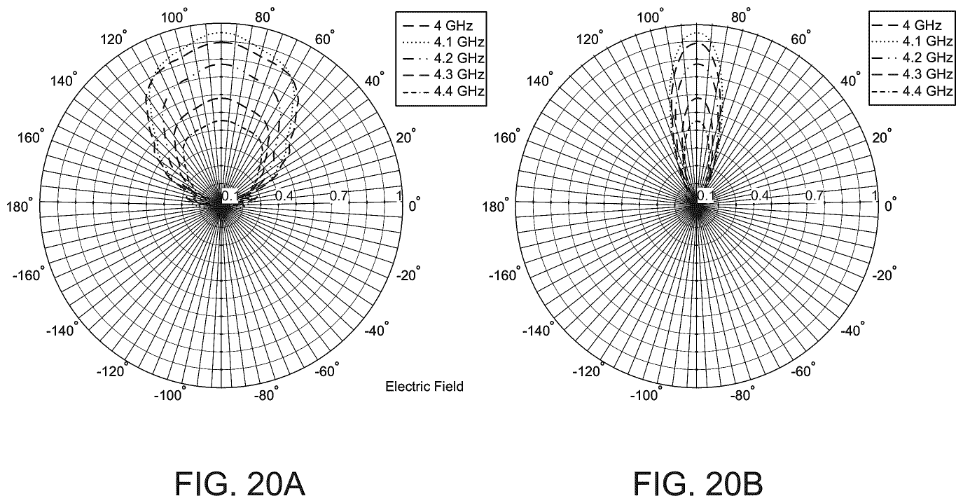

FIGS. 20A and 20B show the normalized electric field radiation patterns for the XZ horizontal plane and YZ transverse plane, respectively, at frequencies ranging between 4-4.4 GHz. To understand whether the enhanced directivity is a broadband feature, similar radiation patterns for both planes are shown in the polar diagrams of FIGS. 20A and 20B. It is apparent from the radiation patterns that the directionality and absence of side lobes are consistent features over the frequency range, with the transverse plane (YZ) radiation patterns showing relatively negligible radiation leakage down the borehole (Y-axis direction). The corresponding directivity remains in excess of D=20.0 for the frequency range 4-4.4 GHz. The directivity was calculated from the MultiPhysics FEA. The presence of electrically conductive media can affect the simple dipole case. The directivity parameters described for the classical dipole configurations in a vacuum media are not necessarily representative of the downhole performance. For comparison as a reference, the identical 3D FEA was conducted for a case of the electric dipole without the metamaterial.

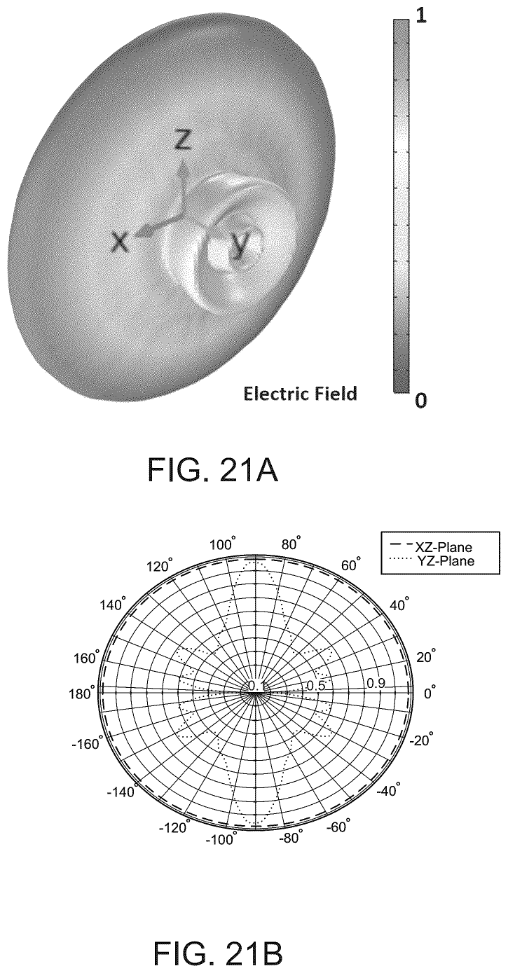

FIGS. 21A and 21B show the normalized electric field radiation patterns for a dipole at 3.9 GHz without a metamaterial. A 3D simulation of the electric field radiation pattern is shown in FIG. 21A. A 2D simulation in FIG. 21B shows the electric field radiation pattern in the horizontal XZ plane and the transverse YZ plane. Both the figures show a significant radiation leakage down the borehole (Y-axis) due to side lobes in the radiation pattern. The resulting directivity of D=2.6 is calculated from the MultiPhysics FEA

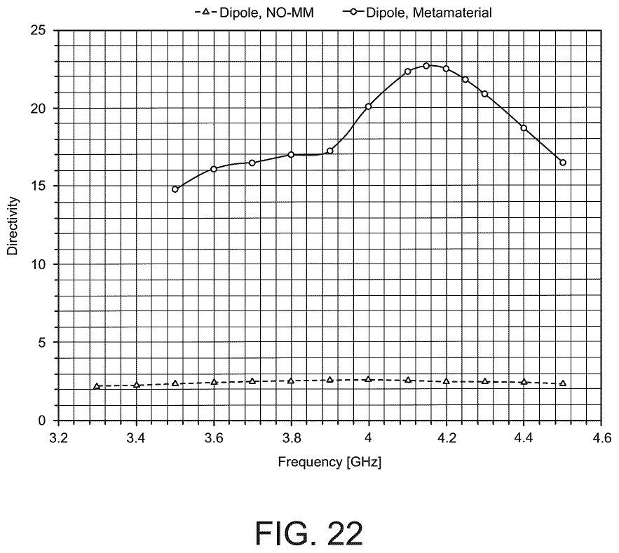

FIG. 22 is a comparison of the radiation pattern directivities obtained for a dipole with and without a metamaterial. The plot shows that the directivity of the radiation pattern is enhanced in the presence of a metamaterial.

### Dipole Metamaterial Implementation

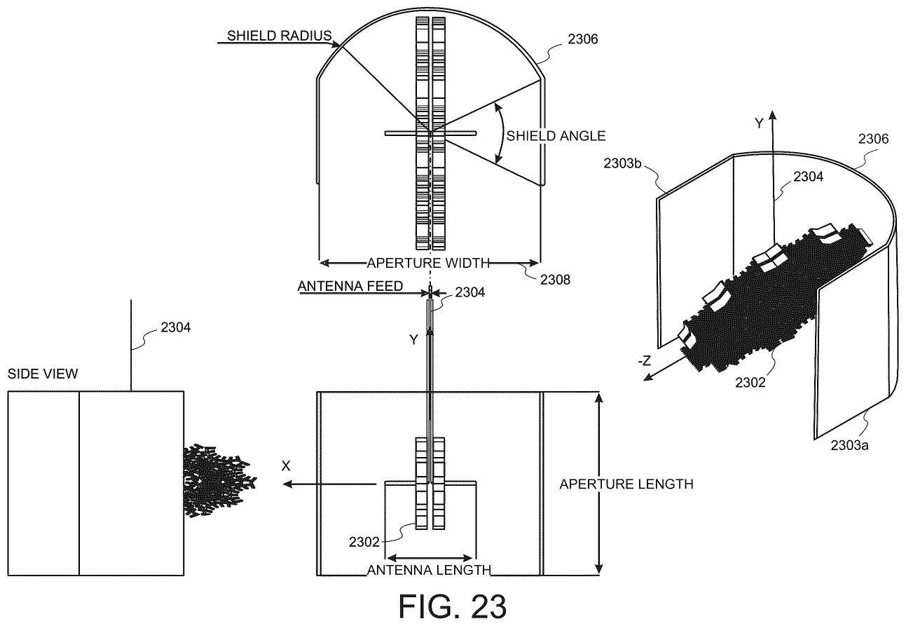

FIG. 23 shows the metamaterial antenna implementation in the dipole source module. The coordinate axes coincide with the orientations referenced in FIGS. 19A-B and FIGS. 20A-B. FIG. 23 shows the orientation of the metamaterial plane (YZ) 2302, which is perpendicular to the electric dipole orientation (X-axis), and coincident with the borehole axis (Y-axis).

The figure also shows the configuration for the implementation which involves an antenna feed 2304 positioned parallel with the axis of an imaging sonde (not shown, parallel with the borehole, Y-axis). The antenna feed is centered in between two metamaterial cell structures.

A semi-cylindrical electrically conductive reflector 2306 has a shield structure and is positioned concentric with the imaging sonde diameter. The shield structure is rectangular and arced to form a semi-circular portion with two extending portions 2303a and 2303b. The shield structure includes a rectangular radiation opening also known as an aperture 2308 which is parallel to the XY-plane. The shield structure covers an uphole portion of the metamaterial lens (and metamaterial absorbers) and partly covers a downhole portion of the metamaterial lens (and metamaterial absorbers), which depends on the shield angle. In some implementations, the shield angle is 30°. The absorption metamaterial cells previously described are positioned parallel to the XZ-plane at each end of the aperture length, perpendicular to the Y-axis direction to isolate the receiver array from any radiation leakage in the borehole axis. The semi-cylindrical electrically conductive reflector 2306 is configured to conduct the EM radiation in one direction to enhance the EM radiation directivity in the azimuthal direction.

Thus, particular implementations of the subject matter have been described. Other implementations are also within the scope of the following claims.

### Examples

Certain aspects of the subject matter described here can be implemented as a borehole radar system in a wellbore. The borehole radar system includes a well logging tool formed from a nonconductive material. The well logging tool is configured to be installed within a borehole. An electric dipole source is disposed in the center of the well logging tool. The electric dipole source is configured to be installed within the borehole, where the electric dipole source is configured to generate electromagnetic energy, to be transmitted through a subterranean zone in which the borehole is formed. A metamaterial lens encloses the electric dipole source. The metamaterial lens is installed within the borehole which is configured to amplify the electromagnetic energy generated by the electric dipole source.

An aspect combinable with any other aspect includes the following features. The electric dipole source has a frequency between about 1.7 GHZ and about 2.75 GHz.

An aspect combinable with any other aspect includes the following features. The electric dipole source has a frequency between about 1 GHz and about 5 GHz.

An aspect combinable with any other aspect includes the following features. The metamaterial lens is formed from a copper mesh.

An aspect combinable with any other aspect includes the following features. The copper mesh is isolated from a conductive wellbore fluid within the borehole using a fiberglass structural tool housing.

An aspect combinable with any other aspect includes the following features. The metamaterial lens is a copper grid printed on a substrate.

An aspect combinable with any other aspect includes the following features. The metamaterial lens has a geometry based, at least in part, on canonical Rhodonea conformal mapping contours or stretching transformations to mimic a spider web geometry.

An aspect combinable with any other aspect includes the following features. The borehole radar system further includes a receiver axially offset from the electric dipole source and the metamaterial lens. The receiver is configured to be installed within the borehole. The receiver is configured to receive a response to the electromagnetic energy transmitted through the subterranean zone by the electric dipole source. A metamaterial absorber is axially offset from the receiver, the electric dipole source, and the metamaterial lens. The metamaterial absorber is configured to isolate the receiver from electromagnetic energy traveling axially through the borehole.

An aspect combinable with any other aspect includes the following features. The metamaterial absorber is a first metamaterial absorber, where the borehole radar system includes a second metamaterial absorber which is axially offset from the receiver, the electric dipole source, the metamaterial lens, and the first metamaterial absorber. The second metamaterial absorber is configured to isolate the receiver from electromagnetic energy traveling axially through the borehole.

An aspect combinable with any other aspect includes the following features. The receiver is enhanced with a metamaterial.

An aspect combinable with any other aspect includes the following features. The first metamaterial absorber and the second metamaterial absorber are downhole of the receiver.

An aspect combinable with any other aspect includes the following features. The first metamaterial absorber is uphole of the electric dipole source and the second metamaterial absorber is downhole of the electric dipole source.

An aspect combinable with any other aspect includes the following features. The electric dipole source is enhanced with a metamaterial.

An aspect combinable with any other aspect includes the following features. The electric dipole source is embedded within an interior of the wellbore logging tool. When the wellbore logging tool with the embedded electric dipole source is immersed in a wellbore fluid within the borehole, the electric dipole source is configured to produce a quadrupole radiation pattern propagating into the subterranean zone in which the borehole is formed.

An aspect combinable with any other aspect includes the following features. A reflector is installed within the subterranean zone. The reflector is configured to reflect the electromagnetic energy generated by the electric dipole source.

An aspect combinable with any other aspect includes the following features. The reflector is a semi-cylindrical shape and configured to conduct in one direction to enhance a radiation directivity in an azimuthal direction.

An aspect combinable with any other aspect includes the following features. The metamaterial is oriented in a plane perpendicular to an axis of orientation of the electric dipole source.

An aspect combinable with any other aspect includes the following features. A shield structure is positioned concentric with the axis of orientation of the electric dipole source.

An aspect combinable with any other aspect includes the following features. The shield structure is semi-cylindrical and covers an uphole portion and partly a downhole portion of the metamaterial lens.

An aspect combinable with any other aspect includes the following features. The shield structure defines an opening within which the electric dipole source is positioned. The opening is perpendicular to the axis of orientation of the electric dipole source.

1. A borehole radar system, comprising:
a well logging tool formed from a nonconductive material, the well logging tool configured to be installed within a borehole;
an electric dipole source disposed in the center of the well logging tool, the electric dipole source configured to be installed within the borehole, the electric dipole source configured to generate electromagnetic energy to be transmitted through a subterranean zone in which the borehole is formed; and
a metamaterial lens that encloses the electric dipole source, the metamaterial lens configured to be installed within the borehole, the metamaterial lens configured to amplify the electromagnetic energy generated by the electric dipole source.

2. The borehole radar system of claim 1, wherein the electric dipole source has a frequency between about 1.7 GHZ and about 2.75 GHz.

3. The borehole radar system of claim 1, wherein the electric dipole source has a frequency between about 1 GHz and about 5 GHz.

4. The borehole radar system of claim 1, wherein the metamaterial lens is formed from a copper mesh.

5. The borehole radar system of claim 4, wherein the copper mesh is isolated from a conductive wellbore fluid within the borehole using a fiberglass structural tool housing.

6. The borehole radar system of claim 1, wherein the metamaterial lens is a copper grid printed on a substrate.

7. The borehole radar system of claim 1, wherein the metamaterial lens has a geometry based, at least in part, on canonical Rhodonea conformal mapping contours or stretching transformations to mimic a spider web geometry.

8. The borehole radar system of claim 1, further comprising:
a receiver axially offset from the electric dipole source and the metamaterial lens, the receiver configured to be installed within the borehole, the receiver configured to receive a response to the electromagnetic energy transmitted through the subterranean zone by the electric dipole source; and
a metamaterial absorber axially offset from the receiver, the electric dipole source and the metamaterial lens, the metamaterial absorber configured to isolate the receiver from electromagnetic energy traveling axially through the borehole.

9. The borehole radar system of claim 8, wherein the metamaterial absorber is a first metamaterial absorber, wherein the borehole radar system comprises a second metamaterial absorber axially offset from the receiver, the electric dipole source, the metamaterial lens and the first metamaterial absorber, the second metamaterial absorber configured to isolate the receiver from electromagnetic energy traveling axially through the borehole.

10. The borehole radar system of claim 9, wherein the receiver is enhanced with a metamaterial.

11. The borehole radar system of claim 9, wherein the first metamaterial absorber and the second metamaterial absorber are downhole of the receiver.

12. The borehole radar system of claim 9, wherein the first metamaterial absorber is uphole of the electric dipole source, wherein the second metamaterial absorber is downhole of the electric dipole source.

13. The borehole radar system of claim 1, wherein the electric dipole source is enhanced with a metamaterial.

14. The borehole radar system of claim 1, wherein the electric dipole source is embedded within an interior of the wellbore logging tool, wherein, when the wellbore logging tool with the embedded electric dipole source is immersed in a wellbore fluid within the borehole, the electric dipole source is configured to produce a quadrupole radiation pattern propagating into the subterranean zone in which the borehole is formed.

15. The borehole radar system of claim 1, further comprising a reflector installed within the subterranean zone, the reflector configured to reflect the electromagnetic energy generated by the electric dipole source.

16. The borehole radar system of claim 15, wherein the reflector is a semi-cylindrical shape and configured to conduct in one direction to enhance a radiation directivity in an azimuthal direction.

17. The borehole radar system of claim 1, wherein the metamaterial is oriented in a plane perpendicular to an axis of orientation of the electric dipole source.

18. The borehole radar system of claim 17, further comprising a shield structure positioned concentric with the axis of orientation of the electric dipole source.

19. The borehole radar system of claim 18, wherein the shield structure is semi-cylindrical and covers an uphole portion and partly a downhole portion of the metamaterial lens.

20. The borehole radar system of claim 19, wherein the shield structure defines an opening within which the electric dipole source is positioned, wherein the opening is perpendicular to the axis of orientation of the electric dipole source.
